(19) United States
(12) Patent Application Publication
(10) Pub. No.: US 2008/0274870 A1
(43) Pub. Date: Nov. 6, 2008

(54) Refractory Ceramic Product

(75) Inventor: Robert Treimer, Leoben (AT)

Correspondence Address: WALKER & JOCKE, L.P.A., 231 SOUTH BROADWAY STREET, MEDINA, OH, 44256, US

(73) Assignee: REFRACTORY INTELLECTUAL PROPERTY GMBH & CO. KG, Wien (AT)

(21) Appl. No.: 11/915,276

(22) PCT Filed: May 10, 2006
(86) PCT No.: PCT/EP2006/004357

§ 371 Date: Dec. 4, 2007

(30) Foreign Application Priority Data
May 30, 2005 (AT) GM 353/2005

(51) Int. Cl. C04B 35/443; C04B 35/03; C04B 35/04; C04B 35/48; C04B 35/185; C04B 35/01; C04B 35/109; C04B 35/10; C04B 35/42

(52) U.S. Cl. 501/104; 501/94; 501/123; 501/108; 501/117; 501/120; 501/127; 501/128; 501/106; 501/103; 501/121; 501/125

(57) ABSTRACT

The invention relates to a refractory ceramic product which comprises: a) ≧93% by weight of at least one refractory basic component and b) ≦7% by weight of at least one anticorrosive component from the group including: b1) transition metals, b2) compounds of transition metals with each other, b3) non-oxidic compounds of transition metals, b4) oxidic compounds of transition metals, b5) compounds of the transition metals with Ca, Ba, Sr.

The present invention relates to a refractory ceramic products in particular a refractory ceramic moulded article.

Refractory ceramic products, and in particular compositions as well as moulded parts, are used to line metallurgical melting vessels and are also used as functional parts, in particular in the context of secondary metallurgical processes.

This applies to applications in the ferrous metal industry as well as to applications in the non-ferrous metal industry.

The refractory material comes into contact not only with the metallurgical melts, but also with corresponding slags. To this extent the refractory material is subjected to a considerable chemical/metallurgical corrosive attack.

Among the known basic and non-basic types of material, hitherto MgCr products with Cr₂O₃ as protective oxide exhibit the best corrosion protection against an attack by in particular acidic, iron silicate-containing and/or copper-containing slags. However, these types of materials have the disadvantage that, on account of the presence of chromium oxide, they can release toxic Cr⁶⁺.

There has therefore been no lack of attempts to improve the corrosion resistance of refractory ceramic products in other ways.

In this connection the use of so-called “corrosion inhibitors” is known. These are additives that are mixed with the batch, and with the aid of which the corrosion of the finished product is said to be reduced.

The object of the invention is accordingly to provide a possibility of improving the corrosion behaviour of refractory ceramic products in the high-temperature application range (>1200° C., in particular >1500° C.) and in particular without at the same time releasing environmentally harmful substances in use.

In numerous experiments it has been found that there are other groups of elements or compounds as an alternative to chromium oxide, which are not toxic and dramatically reduce the corrosion tendency of an associated fired finished product, and specifically do not have any negative effects on the mechanical behaviour of the products or any negative effects on the temperature resistance and temperature cycle resistance.

These groups are in the widest sense defined by the elements of the transition metals (according to the IUPAC definition, Romp “Chemielexikon” 9^{th} Edition, ISBN 3-13-735109-X, page 4787 ff) and their compounds.

These groups include compounds of the transition metals with one another, such as yttrium tungstate, wolframite (Fe, Mn)WO₄ or columbite [(Fe,Mn)(Nb,Ta)₂]O₆.

These groups also include those non-oxidic compounds of transition metals that are not already included in the above group, such as molybdenum disilicide (MOSi₂), MO₅Si₃ and FeMo.

In particular corrosion-inhibiting properties have been observed in compounds of the transition metals with alkaline earth elements.

The aforementioned corrosion-inhibiting substances are formed by firing (see the following information regarding the choice of a raw material batch) or are added to the finished product, for example infiltrated into the product by vacuum treatment. These substances advantageously accumulate in the cavities (interstices) between the grains of the refractory material (refractory base component) and help to reduce corrosive attack by the slag (especially in the case of the aforementioned acidic slags). With the binding of hydration-sensitive Ca with a transition metal, the hydration tendency is at the same time reduced. This is also true of non-impregnated products.

In its most general embodiment the invention comprises a refractory ceramic product which contains
a) ≧93 wt. % of at least one refractory base component and
b) ≦7 wt. % of at least one corrosion-inhibiting component from the group:
b1) transition metals
b2) compounds of transition metals with one another
b3) non-oxidic compounds of transition metals
b4) oxidic compounds of transition metals
b5) compounds of the transition metals with Ca, Ba, Sr.

In this connection one or more of the group members b1 to b5 can be excluded.

Various modifications follow from the features of the sub-claims and the other description documents.

The raw material batch is appropriately adjusted if the corrosion-inhibiting components have not already been introduced by impregnating the finished fired product. The batch thus contains appropriate additives.

This group of additives includes for example metallic molybdenum, molybdenum compounds, metallic tungsten and tungsten compounds.

Molybdenum and also tungsten have similarities with chromium, but are not toxic. Both metals can easily be alloyed with other metals such as aluminium, lead, iron, nickel, manganese or chromium Apart from these alloys other molybdenum and tungsten compounds are suitable for use as additives, for example MoSi₂, Mo₅Si₃, FeMo, WO₃, WSi₂ or niobium and tantalum compounds.

It is also possible to admix further components with the batch, for example a binder or antioxidants.

The invention includes ceramically bound refractory products as well as chemically bound products. The refractory ceramic products can be monolithic compositions (masses) mortars or the like. In particular the invention refers however to the production of refractory ceramic moulded parts, for example in the form of bricks, panels, sleeves or the like.

Insofar as masses are involved, these also include hydraulically bound compositions.

The refractory base component can be at least a basic base component, for example from the group: sintered magnesia, fused magnesia, magnesia-chromite, XY₂O₄ spinel (where X=Mg, Fe, Mn, Zn and Y=Al, Fe, Cr), dolomite sinter, etc. A suitable base component can at least in part also be a non-basic base component, for example from the group: alumina (Al₂O₃), corundum, ZrO₂, zirconium silicate (ZrO₂ SiO₂), mulltea, TiO₂.

A corresponding batch can be prepared in the normal way, for example by mixing the refractory base component with a binder, followed by forming/shaping (for example by compression) and firing to effect sintering, in particular at temperatures >1200° C., but also at temperatures >1500° C.

The corrosion-inhibiting additive is most suitably incorporated as finely ground powder (d₅₀≦150 μm, in particular ≦100 μm).

The additives can be used as primary raw materials. It is however also possible to use recycling materials.

Molybdenum-containing additives of the aforementioned type can be prepared for example from burnt off heating elements by suitable comminution. Such heating elements consist for example of molybdenum disilicide (MoSi₂), in some cases also in combination with tungsten compounds. A valuable waste product is thereby made available as raw material for the use according to the invention.

The aforementioned corrosion-inhibiting compounds such as Ca molybdate or tungstate may be formed during the firing of the products, whereby calcium for example is advantageously bound. At the same time the hydration susceptibility of the finished product decreases.

The invention is described in more detail hereinafter with the aid of various examples of implementation.

For this, a dynamic drip slag test according to ASTM Standard C 768 for bricks/mattes from the non-ferrous metal industry was carried out on various refractory materials. The slag had the following composition (in M %) (determination after oxidising annealing):

| | |
|---|---|
| SiO₂: | 23 |
| Fe₂O₃: | 43 |
| SO₃: | 9 |
| CuO: | 13 |
| PbC: | 3 |
| ZnO: | 5 |
| Al₂O₃: | 1 |
| Remainder | 3 |
| | 100 |

The following test bodies fired at 1650° C. were investigated in air at a test temperature of 1480° C. (grain size data refer to the batch):

Example 1: 100 wt. % sintered magnesia (≦6 mm)
Example 2: 93 wt. % sintered magnesia (≦6 mm), 7 wt. % of finely particulate (100 μm) MgO suspension, 1 wt. % MoSi₂ (as powder <100 μm)
Example 3: 100 wt. % magnesia-chromite
Example 4: 99.7 wt. % magnesia-chromite, 0.3 wt. % FeMo (<100 μm)

The aforementioned drip slag test gave the following wear volumes:

Example 1: 65 cm³
Example 2: 24 cm³
Example 3: 37 cm³
Example 4: 2.2 cm³

The results of the wear test confirm that products according to the invention by use of the aforementioned additives or with the aforementioned corrosion-inhibiting phases have a significantly reduced wear volume. In the case of Example 4 the wear volume is so low that the corresponding brick/matte can be regarded as virtually corrosion resistant to the droplet action of fayalitic slag

Individual or sub-groups can be excluded from the groups of the additives (for the batch) or elements and Compounds (in the finished product).

1. Refractory ceramic product comprising
a) ≧93 wt. % of at least one refractory base component and
b) ≦7 wt. % of at least one corrosion-inhibiting component from the group:
b1) transition metals
b2) compounds of transition metals with one another
b3) non-oxidic compounds of transition metals
b4) oxidic compounds of transition metals
b5) compounds of the transition metals with Ca, Ba, Sr.

2. Product according to claim 1, in which the amount of the corrosion-inhibiting component is c 5 wt. %.

3. Product according to claim 1, in which the amount of the corrosion-inhibiting component is ≦3 wt. %.

4. Product according to claim 1, in which the amount of the corrosion-inhibiting component is ≦2 wt. %.

5. Product according to claim 1, in which the amount of the corrosion-inhibiting component is ≦1 wt. %.

6. Product according to claim 1, in which the amount of the corrosion-inhibiting component is ≦0.5 wt. %.

7. Product according to claim 1, with at least one corrosioni-inhibiting component from the group: Ca-, Ba-, Sr-molybdate, tungstate, niobate and tantalite.

8. Product according to claim 1, in which at least one refractory base component is a basic base component.

9. Product according to claim 8, in which the basic base component is derived from the group sintered magnesia, fused magnesia, magnesia-chromite, XY₂O₄ spinel, dolomite sinter.

10. Product according to claim 1, in which at least one refractory base component is a non-basic base component.

11. Product according to claim 10, in which the non-basic base component is derived at least in part from the group alumina, corundum, ZrO₂, zirconium silicate, mullite, TiO₂.

12. Product according to claim 1, in which the corrosion-inhibiting component(s) contains no non-oxidic compounds of Zr, Ti, Cr, Hf, Fe and no compounds of these elements with Ca.

13. Product according to claim 1 with a wear volume according to ASTM C 768 of <50 cm³.

14. Product according to claim 1 with a wear volume according to ASTM C 768 of <30 cm³.
